(19) United States
(12) Patent Application Publication
(10) Pub. No.: US 2018/0297336 A1
(43) Pub. Date: Oct. 18, 2018

(54) Polyvinyl Chloride-Free Decorative Surface Coverings

(71) Applicant: Tarkett GDL, Lentzweiler (LU)

(72) Inventor: Guillaume Fascella, Wiltz (LU)

(21) Appl. No.: 15/569,491

(22) PCT Filed: Apr. 18, 2016
(86) PCT No.: PCT/EP2016/058546

§ 371 Date: Oct. 26, 2017

(30) Foreign Application Priority Data
Apr. 29, 2015 (EP) 15165719.4

(51) Int. Cl. B32B 27/08; B32B 27/40; B32B 27/32; C08J 7/12; C08L 75/14; C08L 23/08; C08L 33/12

(52) U.S. Cl. CPC B32B 27/08; B32B 27/40; B32B 27/32; C08J 7/123; C08L 75/14; B32B 2255/26; C08L 33/12; B32B 2451/00; B32B 2471/00; B32B 2607/02; B32B 2307/554; C08L 23/0815

(57) ABSTRACT

The present invention is related to PVC-free decorative surface coverings, in particular floor or wall coverings, comprising one or more polyolefin layer(s) and a cross-linked polyurethane top-layer comprising anionic or cationic salt groups. The invention is further related to a method for the production of said surface coverings.

### FIELD OF THE INVENTION

The present invention is related to polyvinyl chloride-free decorative floor and wall coverings comprising a polyurethane top coat. The invention is further related to a method for the production of said surface coverings.

### STATE OF THE ART

Materials for floor, wall and ceiling coverings should possess a wide variety of properties. Particularly important for materials used for floor coverings are good wear, abrasion, scratch and indentation resistance and good indentation recovery to reduce visible scratches and indentations of furniture and rolling objects, such as office chairs.

Well known floor coverings are based on polyvinyl chloride (PVC). PVC-based materials have many desirable properties, such as good filler acceptance, flexibility and scratch resistance. However, in more recent years attention has been focused on the disadvantages of PVC-based flooring.

Typical PVC surface coverings include a PVC-plastisol. The plastisol typically consists of PVC particles, plasticizer, heavy metal additives and inorganic filler. The surface covering is formed in a spreading process by laying-down the plastisol on a backing layer and subsequently fusing and gelling said plastisol at temperatures comprised between 130 and 180° C.

The use of heavy metal stabilizers (e.g. dilauryl tin distearate or carboxylates of barium and cadmium, barium and zinc or calcium and zinc) is especially important to avoid degradation of the PVC polymer.

Plasticizers have a tendency to migrate, which results in a gradual deterioration in resiliency and build-up of a sticky residue that can lead to dirt accumulation, and the plasticizers can form pathways in the polymer for dye migration which can render printed patterns less distinct.

The ecological concerns respecting the PVC decorative covering segment pertain to recyclability or energy recovery, volatile organic content levels, and the use of heavy metal stabilizers.

The hydrogen chloride and heavy metal ash from decomposition of the heavy metal stabilizers are undesired consequences from the incineration of scrap associated with manufacturing and installation of PVC-based covering materials.

Consequently, even though PVC offers an excellent mechanical, acoustic and heat insulation compromise in its application to floor coverings, the manufacturers of these coverings have been looking for a substitute for it, providing an answer to the following three points of concern:
releasing no toxic gas when burnt, such as chlorine, hydrochloric acid, sulfur dioxide or nitrogen oxides;
having properties, especially mechanical properties and fire resistance, of the same order as those obtained today with PVC;
being capable of processing or fabrication on existing equipment, especially by extrusion, calendering, and the like.

In recent years, olefin based decorative surface covering materials have become popular and already have been subject of a considerable number of patents.

PVC-free floor and wall coverings for example are disclosed in EP 0257796 (B1), EP 0742098 (B1), EP 0775231 (B1), U.S. Pat. No. 4,379,190, U.S. Pat. No. 4,403,007, U.S. Pat. No. 4,438,228, U.S. Pat. No. 5,409,986, U.S. Pat. No. 6,214,924, U.S. Pat. No. 6,187,424, U.S. Pat. No. 6,287,706, US 2008/0206583, US 2011/0223387, US 2011/0305886, JP 2004168860, JP 2002276141, JPH 07125145, JPH 06128402, JP 2000063732, JPH 1148416, JP 2000045187, JPH 0932258, JPS 6092342 and JPH 09302903.

Thermoplastic layers show various limitations and disadvantages, such as insufficient gloss retention, insufficient wear and abrasion resistance, stain resistance, scuff resistance, and resistance to various chemical agents among others.

A method to remedy these shortcomings consists in the application of a coating, obtained from thermal and/or radiation curing of a liquid composition of monomers and/or polymers, as the outermost surface layer on the thermoplastic layer.

In general these coatings are polyurethane, polyester, polyether, polycarbonate poly(meth)acrylate and/or epoxy based; their use as a topcoat of decorative polyvinyl chloride-based surface coverings is disclosed in for example EP 0210620 (B1), U.S. Pat. No. 4,100,318, U.S. Pat. No. 4,393,187, U.S. Pat. No. 4,598,009, U.S. Pat. No. 5,543,232, U.S. Pat. No. 6,586,108, US 2013/0230729, DE 4421559, FR 2,379,323, KR 20010016758, JPH 06279566, CN 103242,742 and WO 03/022552.

US 2008/0206583 discloses polyolefin based decorative surface coverings comprising a radiation cured topcoat system obtained from radiation curing a composition comprising (a) unsaturated functional acrylates including epoxy, urethane, and/or polyester type oligomers (b) reactive monomers including mono-functional, di-functional and/or multi-functional diluents; (c) other ingredients, such as surfactants, defoaming agents and abrasive resistant particles such as aluminium oxides, etc., and optionally, (d) a photoinitiator. The radiation cured topcoat system comprises a first semi-cured coating layer before receiving a second coating layer for good adhesion.

From economical point of view radiation curable coatings are advantageous since curing, mostly performed around room temperature, is almost immediately. Yet adhesion problems between the radiation cured coating and the polyolefin-layer occur, resulting in moderate to poor wear resistance and chemical resistance properties.

### AIMS OF THE INVENTION

The present invention aims to provide a PVC-free decorative surface covering, in particular floor or wall covering, comprising one or more polyolefin layer(s) and a radiation cured top-layer with good adhesion between said top-layer and the top surface of the polyolefin.

A further aim of the present invention is to provide a process for the production of said surface coverings.

### SUMMARY OF THE INVENTION

The present invention discloses a PVC-free decorative surface covering, in particular floor or wall covering, comprising one or more polyolefin layer(s) and a cross-linked polyurethane top-layer comprising anionic or cationic salt groups. Preferably, the cross-linked polyurethane top-layer is applied directly on one of the polyolefin layer(s).

Preferred embodiments of the present invention disclose one or more of the following features:
the one or more polyolefin layer(s) comprise one or more polyolefin homo and/or copolymer(s) selected from the group consisting of an ethylene homopolymer, an ethylene copolymer comprising alpha-olefins, an olefin copolymer comprising vinyl carboxylate esters, an olefin copolymer comprising alkyl (meth)acrylates, a polyolefin elastomer and a polar group comprising polyolefin;
the cross-linked polyurethane top-layer comprises from 1 to 30% by weight, preferably from 2 to 20% by weight of di-, tri- or tetra oxyethylene and/or di-, tri- or tetra oxypropylene units incorporated into the cross-linked polyurethane top-layer by two ester linkages;
the cross-linked polyurethane top-layer comprises wear resistant particles;
the PVC-free decorative surface covering comprises a mechanical embossed textured and/or patterned structure.

The present invention further discloses a process for the preparation of said decorative surface covering comprising the steps of:
a) providing one or more polyolefin layer(s),
b) subjecting the top surface of the one or more polyolefin layer(s) to a plasma treatment, preferably a corona plasma treatment,
c) applying a radiation curable aqueous polyurethane dispersion on the top surface of said one or more polyolefin layer(s),
d) evaporating water from the aqueous dispersion to form an uncured top-layer comprising an ethylenically unsaturated polyurethane,
e) irradiating the ethylenically unsaturated polyurethane to form a cross-linked polyurethane top-layer.

Preferred embodiments of the process for the preparation of said decorative surface covering disclose one or more of the following features:
the corona treatment is adjusted to provide a surface energy of at least 38 mN/m, preferably of at least 40 mN/m, more of at least 42 mN/m, according to ASTM D2578.
the aqueous radiation curable polyurethane dispersion comprises 20 to 80% by weight, preferably 25 to 60% by weight of radiation curable compounds and from 0.5 to 8% by weight, preferably from 2 to 5% by weight, relative to the radiation curable compounds, of at least one photoinitiator.
the radiation curable compounds of the aqueous radiation curable polyurethane dispersion comprise at least 50% by weight of one or more ethylenically unsaturated polyurethane resin(s) and at most 50% by weight of one or more reactive diluent(s).
the reactive diluents comprise between 20 and 100% by weight, preferably between 30 and 90% by weight, more preferably between 40 and 80% by weight of one or more ethylenically unsaturated polyalkylene glycols selected from the group consisting of diethylene glycol di(meth)acrylate, triethylene glycol di(meth)acrylate, tetraethylene glycol di(meth)acrylate, dipropylene glycol di(meth)acrylate, tripropylene glycol di(meth)acrylate, tetrapropylene glycol di(meth)acrylate.
the aqueous dispersion is applied on the top surface of the one or more polyolefin layer(s) in step c) at a temperature comprised between 25° C. and 60° C. and preferably between 30° C. and 50° C.
the one or more polyolefin layer(s), comprising the uncured top-layer of step d) are mechanical embossed before initiating step e).
mechanical embossing is performed at a surface temperature comprised between 100° C. and 200° C.
the dried coating is irradiated in step e) at a temperature comprised between 30° C. and 70° C. preferably between 30° C. and 60° C.

### DETAILED DESCRIPTION OF THE INVENTION

The object of the present invention is to provide polyolefin based decorative floor and wall coverings comprising a polyurethane comprising top-layer obtained from radiation curing a radiation curable aqueous polyurethane dispersion.

The decorative surface coverings of the present invention preferably comprise a backing layer, a decor layer, at least one wear layer all comprising one or more olefin (co)polymers and a coating comprising polyurethane on the top surface of the wear layer. The decorative surface coverings preferably comprise one or more polyolefin layers decorated with a pattern and color by any printing means. Prior to the printing process, the one or more polyolefin layers optionally are provided with a primer.

Additional layers can be present. The additional layers can be used for a variety of purposes, such as for reinforcement. For example, the additional layer can comprise a polyolefin blend and a glass-fiber mat.

In another embodiment the decorative surface coverings comprise one PVC-free layer and one layer comprising polyurethane on the top-surface of the PVC-free layer.

The one or more polyolefin layer(s) comprise a one or more homo and/or copolymers selected from the group consisting of an ethylene homopolymer, a propylene homopolymer, an ethylene copolymer comprising alpha-olefins, an olefin copolymer comprising vinyl carboxylate esters, an olefin copolymer comprising alkyl (meth)acrylates, a polyolefin elastomer and a polar group comprising polyolefin.

The ethylene homopolymer preferably is selected from the group consisting of low density polyethylene (“LDPE”), medium density polyethylene (“MDPE”) and very low density polyethylene (“VLDPE”).

The polyethylene copolymers preferably comprise one or more linear or branched alpha-olefins co-monomers such as C3-C20 alpha-olefins and preferably C3-C12 alpha-olefins.

The ethylene copolymers comprising vinyl carboxylate esters preferably are copolymers of ethylene with at least one co-monomer selected from the group consisting of vinyl esters of saturated carboxylic acids wherein the acid moiety has up to 4 carbon atoms. The co-monomer preferably is vinyl acetate.

The ethylene copolymers comprising alkyl (meth)acrylate monomers preferably are copolymers of ethylene with at least one co-monomer selected from the group consisting of C1-C20 (meth)acrylates.

The polyolefin elastomer preferably is a homopolymer of C2-C20 olefins, such as ethylene, propylene, 4-methyl-1-pentene, etc., or a copolymer of ethylene with at least one C3-C20 alpha-olefin and/or C2-C20 acetylenically unsaturated monomer and/or C4-C18 diolefins.

The polar group comprising polyolefin is derived from a polypropylene homopolymer, a polypropylene random copolymer, or a polypropylene ethylene copolymer, or an elastomeric copolymer, or a copolymer of ethylene and an alpha-olefin having C4-C10.

The polar group can be any polar group that can be used to functionalize the polyolefins. The polar group may be obtained, e.g., from unsaturated organic acid anhydrides such as maleic anhydride and/or unsaturated carboxylic acids such as for example (meth)acrylic acid.

Part or all of the polar groups of the polar group comprising polyolefin may be neutralized by a metal cation, such as for example a zinc or magnesium cation.

The one or more polyolefin layer(s) further may comprise one or more styrene based elastomers such as for example styrene-butadiene-styrene, styrene-isoprene-styrene, styrene ethylene-butylene-styrene block copolymers.

The one or more polyolefin layer(s) further may comprise organic or inorganic fillers, lubricants and additives.

The polyurethane comprising coating on the top surface of the one or more polyolefin layer(s) is obtained from radiation curable aqueous polyurethane dispersions after being subjected to actinic irradiation.

The radiation curable aqueous polyurethane dispersion for being used in the present invention in general is obtained from the reaction of
a) at least one polyisocyanate,
b) at least one hydrophilic compound containing at least one reactive group capable to react with isocyanate groups and at least one group which is capable to render the polyurethane dispersible in aqueous medium either directly or after a reaction with a neutralizing agent to provide a salt,
c) at least one polymerizable ethylenically unsaturated compound containing at least one reactive group capable to react with isocyanate groups and
d) at least one compound which differs from compound (c) containing at least one reactive group capable to react with isocyanate groups.

By polyisocyanate compound (a) is meant to designate organic compounds comprising at least two isocyanate groups. The polyisocyanate compound usually comprises not more than three isocyanate groups. The polyisocyanate compound (a) is most preferably a di-isocyanate. The polyisocyanate compound is generally selected from aliphatic, cycloaliphatic, aromatic and/or heterocyclic polyisocyanates or combinations thereof.

The hydrophilic compound (b) is generally a polyol or polyamine comprising a functional group that can exhibit an ionic or non-ionic hydrophilic nature. Preferably it is a polyol or polyamine containing one or more anionic salt groups, such as a carboxylate and sulfonate salt groups or acid groups which may be converted to an anionic salt group, such as carboxylic acid or sulfonic acid groups. A typical example is 2,2-dimethylolpropionic acid and 2,2-dimethylolbutanoic acid.

Alternatively a polyol containing one or more potentially cationic groups such as amine groups, which may be converted in ammonium salt groups such as for example N-methyldiethanolamine, can be used.

Polymerizable ethylenically unsaturated compound (c) in general have one or more reactive groups capable to react with isocyanate groups and at least one (meth)acrylated group.

Compounds (c) in general contain one or more unsaturated function such as acrylic or methacrylic group and essentially one nucleophilic function capable of reacting with isocyanate, such as a hydroxyl group. Preferred are (meth)acryloyl mono-hydroxy compounds, more particularly poly(meth)acryloyl mono-hydroxy compounds.

Useful compounds include the esterification products of aliphatic and/or aromatic polyols with (meth)acrylic acid having a residual average hydroxyl functionality of about 1.

Other suitable compounds are the (meth)acrylic esters with linear and branched polyols in which at least one hydroxy functionality remains free, like hydroxyalkyl(meth)acrylates having 1 to 20 carbon atoms in the alkyl group. Preferred molecules in this category are hydroxyethyl (meth)acrylate, hydroxypropyl (meth)acrylate, hydroxybutyl (meth)acrylate.

Compound (d), containing at least one reactive group capable to react with isocyanate groups, in general comprises monomeric mono- and/or polyols and/or mono- and/or polyamines.

Compound (d) furthermore comprises oligomeric and/or polymeric hydroxy-functional compounds. These oligomeric and/or polymeric hydroxy-functional compounds are, for example, polyesters, polyethers, polyether-esters, polycarbonates, polyether carbonate polyols and polycarbonate polyesters having a functionality of from 1.0 to 3.0. Hydroxyl functional polyesters are particularly preferred.

Usually the dispersion requires the preliminary neutralization of the hydrophilic groups provided by compound (b), such as the carboxylic acid or sulfonic acid groups, into anionic salts. This is generally done by adding a neutralizing agent such as an amine or inorganic bases, comprising monovalent metal cations, to the polymer or the water.

Suitable neutralizing agents for potentially cationic groups include organic and inorganic acids.

The aqueous dispersion preferably comprises reactive diluents containing at least one group which can undergo free radical polymerization. The reactive diluents are employed to the extent of 0 to 50% by weight, preferably of 2 to 40% by weight, more preferably of 5 to 30% by weight, most preferably of 7 to 24% by weight of the ethylenically unsaturated polyurethane and the reactive diluents adding up to 100 weight percentage.

The reactive diluents may be added before the dispersion is made or after. Mostly addition before is preferred.

Reactive diluents are, for example, obtained from reaction of mono- or polyols and the ethoxylated and/or propoxylated derivatives of said alcohols with (meth)acrylic acid.

The reactive diluents preferably comprise between 20 and 100% by weight, preferably between 30 and 90% by weight, more preferably between 40 and 80% by weight, of the total weight all reactive diluents when present, of one or more polyalkylene glycol di(met)acrylate selected from the group consisting of diethylene glycol di(meth)acrylate, triethylene glycol di(meth)acrylate, tetraethylene glycol di(meth)acrylate, dipropylene glycol di(meth)acrylate, tripropylene glycol di(meth)acrylate, tetrapropylene glycol di(meth)acrylate.

The aqueous radiation curable composition in general contains from 20 to 80% by weight, preferably from 25 to 60% by weight of polyurethane and optional reactive diluent.

The aqueous radiation curable composition further comprises additives, such as photoinitiators, curing accelerators, flow agents, wetting agents, antifoaming agents, levelling agents, matting agents, fillers and other customary coating auxiliaries.

Examples of antifoaming agents are polysiloxanes, such as polymethylhydrogensiloxane or polydimethylsiloxane, polyoxyalkylene polysiloxane block copolymers, grafted polyoxyalkylene polysiloxane block copolymers and mixtures thereof with organic oils such as mineral oils such as naphthenic and paraffinic mineral oil, polypropylene oxide, polybutadiene, certain oils of vegetable or animal origin, and the like. Suitable commercially available antifoaming agents are Tego foamex 842 and BYK-088.

Examples of wetting additives are the sodium salt of a naphthalenesulfonic acid-formaldehyde condensation product, e.g. 2,2′-dinaphthylmethane-6,6′-disulfonic acid, sodium salt; aliphatic amines and salts thereof, e.g. containing a long chain aliphatic group, e.g., hexadecyltrimethyl ammonium chloride; or alkylphenolpolyglycol ethers as e.g., nonylphenolpolyglycol ethers or isooctylphenolpolyglycol ether (e.g., p-nonylphenol or p-isooctylphenolethylene oxide adducts having 10 to 20 ethylene oxide units per molecule); modified polydimethylsiloxanes such as polyether modified polydimethylsiloxane and modified polyethers. Suitable commercially available wetting additives are Tego Dispers 650, Disperbyk-185, Tego Glide 410 and BYK-307.

The aqueous radiation curable composition preferably comprises wear resistant particles. The wear resistant particles preferably are transparent and are characterized by a Mohs' hardness of at least 4, preferably at least 6, more preferably at least 8 and most preferably at least 9.

Preferably, the transparent wear resistant particles are materials chosen from the group consisting of α-aluminum oxide, fused corundum, sintered corundum, fully annealed aluminum oxides, sol-gel corundum, aluminum silicates, glass spheres, silica sand and mixtures thereof. The individual grain size fractions can thereby also encompass different solid particles and can consist of mixtures of solid particles. Optionally the wear resistant particles are subjected to a chemical surface treatment. Particularly good results are obtained when with α-aluminum oxide, fused corundum or fully annealed aluminum oxides.

The wear resistant particles are characterized by an average particle size d50 comprised between 0.2 and 100 μm, preferably between 0.5 and 30 μm, more preferably between 2 and 20 μm and are added to the aqueous polyurethane dispersion in an amount comprised between 1 and 15% by weight, preferably between 3 and 12% by weight, more preferably between 5 and 9% by weight based on the total weight of the final dispersion. Suitable commercially available wear resistant particles are Aludor ZWSK aluminum oxide particles.

Examples of pH stabilizers are amines, such as ammonia, dimethylethanolamine and aminomethyl propanol. A suitable commercially available pH stabilizer is Advantex.

Examples of matting additives are precipitated or thermal silicas, organic duroplastic resin particles such as urea formaldehyde resin particles having an average particle size d50 comprised 2 and 20 μm, preferably between 3 and 15 μm, most preferably between 4 and 10 μm, micronized waxes such as micronized polytetrafluorethylene modified polyolefin- or polypropylene waxes. Suitable commercially available matting agents are Syloid ED5 and Lovel 6000.

The photoinitiators for being used in the coating formulation of the present invention are of the unimolecular (type I) or of the bimolecular type (type II).

(Type I) initiators, such as benzoin and its derivatives, benzil ketals, acylphosphine oxides, 2,4,6-trimethyl-benzoyl-diphenylphosphine oxide, bisacylphosphine oxides, phenylglyoxylic acid esters, camphorquinone, alpha-aminoalkylphenones, alpha,alpha-dialkoxyacetophenones and alpha-hydroxyalkylphenones, are furthermore suitable. Suitable (type II) systems are aromatic ketone compounds, such as e.g. benzophenones in combination with tertiary amines, alkylbenzophenones, 4,4′-bis(dimethylamino)benzophenone (Michler's ketone), anthrone and halogenated benzophenones or mixtures of the types mentioned.

Photoinitiators which can easily be incorporated into aqueous coating compositions are preferred. Such products are, for example, Irgacure® 500 (a mixture of benzophenone and (1-hydroxycyclohexyl) phenyl ketone, Ciba, Lampertheim, DE), Irgacure® 819 DW (phenyl-bis-(2,4,6-trimethylbenzoyl)-phosphine oxide, Ciba, Lampertheim, DE), Esacure® KIP EM (oligo-[2-hydroxy-2-methyl-1-[4-(1-methylvinyl)-phenyl]-propanone], Lamberti, Aldizzate, Italy). Mixtures of these compounds can also be employed.

The coating composition according to the present invention comprises between 0.5 and 8% by weight, preferably between 2 and 5% by weight of photoinitiator which may comprise one or more photoinitiators. The amount of photoinitiators is relative to the ethylenically unsaturated group comprising compounds (polyurethane and optional reactive diluents)

The aqueous radiation curable polyurethane dispersion comprises 20 to 80% by weight, preferably 25 to 60% by weight of radiation curable compounds and from 0.5 to 8% by weight, preferably from 2 to 5% by weight, relative to the radiation curable compounds, of at least one photoinitiator.

According to a first aspect of the present invention provides a decorative surface covering, more particularly floor and wall covering, comprising one or more polyolefin layers and a polyurethane top-layer is provided.

According to a second aspect of the present invention a method for producing said decorative surface coverings is provided.

The method comprises:
providing one or more polyolefin layer(s),
subjecting the top surface of the one or more polyolefin layer(s) to a plasma treatment, preferably a corona plasma treatment,
applying an aqueous radiation curable polyurethane dispersion on the top surface of said one or more polyolefin layer(s),
evaporating water from the aqueous radiation curable polyurethane dispersion to form an uncured top-layer comprising an ethylenically unsaturated polyurethane,
irradiating the ethylenically unsaturated polyurethane to form a cross-linked polyurethane top-layer.

The one or more polyolefin layers preferably are produced via one or more processing machines comprising a series of calendar rolls, wherein one or more hot PVC-free paste(s), are processed.

The set temperature of the calendering rolls in general is comprised between 140 and 200° C., preferably between 150 and 190° C., more preferably between 160 and 180° C.

The hot PVC-free paste is prepared by compounding the one or more olefin (co)polymers, the filler(s), the lubricant(s) and the one or more additives in a suitable heated mixer, for example in a twin screw or a single screw extruder, a mixing bowl with heated jacket, a Banbury mixer, continuous mixer, a ribbon mixer or any combination thereof to form a blend.

The PVC-free paste is obtained from melt-mixing at an internal temperature comprised between 180 and 240° C., preferable between 190 and 230° C., more preferable between 200 and 220° C.

The top surface of the one or more polyolefin layers is subjected to a corona treatment, adjusted to provide a surface energy of at least 38 mN/m, preferably of at least 40 mN/m, more of at least 42 mN/m, according to ASTM D2578.

Corona plasma treatment ideally is done on-line immediately before application of the aqueous radiation curable polyurethane dispersion.

The radiation curable aqueous polyurethane dispersion is homogeneously applied on the decorative surface covering standing at a temperature comprised between 25 and 60° C., preferably between 30° C. and 50° C.

After evaporation of water, in a convection oven at about 100° C., the decorative surface covering comprising the polyurethane resin top-layer, standing at a temperature comprised between 20 and 70° C., preferably between 30 and 60° C., then is subjected to actinic radiation, and finally is cooled down to about room temperature.

The radiation curable compositions of the present invention may be applied onto the polyolefin under-layer by any suitable coating process known to those of ordinary skill in the art, for example by direct gravure coating, reverse gravure coating, offset gravure coating, smooth roll coating, curtain coating, spray coating and combinations thereof. Direct gravure coating and smooth roll coating are preferred.

In a preferred embodiment of the method of the present invention, the polyolefin layer(s) comprising the uncured polyurethane resin top-layer, after evaporation of water, is heated to a temperature comprised between 130 and 200° C., and subsequently is mechanically embossed.

The embossed polyolefin layer(s) comprising the uncured polyurethane coating then is cooled down to a temperature comprised between 30 and 70° C., preferably between 30 and 60° C. and subjected to actinic radiation.

Mechanical embossing is performed by pressing a texture into the PVC-free layer comprising the ethylenically unsaturated polyurethane layer atop. Embossing is carried out at a pressure comprised between 10 and 25 kg·cm⁻² and surface temperature comprised between 100° C. and 200° C., preferably between 130° C. and 200° C.

The apparatus for mechanically embossing a substrate in general includes a cooled embossing roller and a backup roller operatively positioned within the embossing roller such that a nip is formed between the backup roller and the embossing roller whereby the substrate may pass through the nip and engage the embossing roller for imparting a mechanically embossed pattern. The apparatus further includes a profilometer capable of quantifying the mechanically embossed pattern as the substrate is being embossed.

In general the texture obtained from mechanical embossing is characterized by a depth comprised between about 10 to 100 μm, a width comprised between about 125 to 400 μm, a wall angle (angle relative to surface) comprised between about 5 to 40 degrees and a frequency of about 4 to 20 features per cm.

After mechanical embossing the ethylenically unsaturated polyurethane resin, standing at a temperature comprised between 20 and 70° C. is cross-linked by exposure to actinic radiation such as ultraviolet (UV) radiation with a wavelength of for instance 250-600 nm.

Examples of radiation sources are medium and high-pressure mercury vapour lamps, lasers, pulsed lamps (flashlight), halogen lamps and excimer emitters.

Preferably, within the context of the present invention, one or more medium pressure mercury vapour UV radiators of at least 80 to 250 W/linear cm are used. Preferably said medium pressure mercury vapour UV radiator(s) is (are) positioned at a distance of from about 5 to 20 cm from the substrate. The irradiating time period preferably is comprised between 1 and 60 seconds for having a radiation dose in the range of from 80 to 3000 mJ/cm2.

On the other hand the ethylenically unsaturated polyurethane layer can be cured by bombardment with high-energy electron beams (EB) at for instance 150-300 keV. For this particular case, coating formulations that do not comprise photoinitiators, are cured. From economical point of view electron-beam curing yet is less attractive.

In general the thickness of the polyurethane top coat is homogeneous over the whole embossed surface and is comprised between 3 and 30 microns, preferable between 8 and 20 microns.

### EXAMPLE

The following illustrative example are merely meant to exemplify the present invention but are not destined to limit or otherwise define the scope of the present invention.

### Example: Preparation of a Stack of Adjacent Polyolefin Layers

A PVC-free paste formulation, according to the formulation as given in table 1, is prepared by melt-mixing wherein the internal temperature of said paste is about 200° C.

TABLE 1

| | Constituent | % by weight |
|---|---|---|
| Polymer | Clearflex CLDO | 7.1 |
| Polymer | Greenflex ML 50 | 7.1 |
| Elastomer | Tafmer DF 710 | 7.1 |
| Polymer | Fusabond 525 | 2.4 |
| Filler | Chalk Superfine | 69.0 |
| | Zinc Oxide Neige A | 2.0 |
| Lubricant | Paraffin | 4.7 |
| Lubricant | Radiacid 0444 | 0.5 |
| Antioxidans | Irganox 1010 | 0.1 |

In table 1, Clearflex® CLDO is very low density polyethylene, with a density of 0.900 g/cm3 from Polimeri;

Greenflex® ML 50 is a copolymer of ethylene and vinyl acetate from Polymeri Europa; Tafmer™ DF 710 is an ethylene-butene elastomer from Mitsui Company; Fusabond® 525 is a maleic anhydride modified ethylene copolymer from Dupont Company; Chalk Superfine is calcium carbonate from Omya; Zinc Oxide Neige A is Zinc oxide from Umicore; Paraffin is a mineral parrafinic process oil from Petrocenter; Radiacid® 0444 is stearic acid from Oleon and Irganox® 1010 is a sterically hindered phenolic antioxidant from BASF.

A glass fiber mat was supplied by JohnsMainville (also called JS) under their designation SH 35/3 having an air permeability of 4500 l/m²·s;

The PVC-free paste of the composition as in table 1 has a dynamic viscosity at 200° C. and a at shear rate of 100/s of 1500 Pa·s.

The glass fiber mat was impregnated with the PVC-free paste of table 1 using the calendaring process wherein the temperature of the cylinders were respectively 170 and 175° C.

The carrier comprising layer thus obtained, with an overall thickness of about 1.2 mm then was subjected to a second calendaring step wherein a layer of about 0.5 mm of PVC-free paste of table 1 was applied on the remaining exposed side of the 1.2 mm carrier comprising layer. The reinforced layer thus obtained has an overall thickness of about 1.7 mm.

The reinforced layer, was then transformed into a decorative surface covering through the application of a top layer.

Hereto a coextruded film of 250 μm of Surlyn® 9020, a zinc ionomer ethylene-(meth)acrylic acid-(meth)acrylate thermoplastic resin and 50 μm of Bynel® 2022, an ethylene-(meth)acrylic acid-(meth)acrylate terpolymer, both form Dupont was contacted, with its 50 μm Bynel® 2022 side, with the 0.5 mm side of the reinforced layer, which first was heated to about 100° C. by means of infrared irradiation. The top layer then was pressed onto the reinforced layer and subsequently heated, for 2.5 minutes, in an oven at an ambient temperature comprised between 160 and 200° C.

After cooling down the above polyolefin stack, the top surface of the top layer was corona treated for 1 second, using a Corona Lab System from Dyne Technology Ltd., whereupon the surface energy increased from 36 mN/m to 41 mN/m.

Subsequently a radiation curable aqueous polyurethane dispersion with a composition as in table 2, was applied by a smooth roll coating process under conditions to have a dry coating thickness comprised between 10 and 12 μm.

TABLE 2

| | |
|---|---|
| UV-PUD | 75.2 |
| pH stabilizer | 0.2 |
| Rheology agent | 0.5 |
| Matting agent | 2.9 |
| Anti-foaming agent | 0.8 |
| Wetting agent | 1.3 |
| Photoinitiator | 1.9 |
| Reactive diluent | 6.0 |
| Abrasive grain | 6.5 |
| water | 4.7 |

In table 2: the ultra-violet curable polyurethane dispersion is Bayhydrol® UV 2720/1 XP from Bayer characterized by a solid content of 40%; the pH stabilizer is Advantex® amine from Eastman; the matting agent is a 55/45 mixture of Deuteron® MK from Deuteron and Acematt®TS 100 from Evonik; the anti-foaming agent is Neocryl® AP 2861 from DSM Coating Resins; the wetting agent is a 69/31 mixture of Disperbyk® 190 and Byk®-348 from Byk Chemie; the photoinitiator is Esacure® KIP 100 F from Lamberti; the reactive diluent is a 68/32 mixture of SR 259 (polyethylene glycol 200 diacrylate) and SR 238 (HexaneDiolDiAcrylate) from Arkema and the abrasive grain is Alodur® ZWSK F 320 from Imerys.

The radiation curable polyurethane dispersion is applied on the corona treated top surface of the PVC-free layer stack standing at about 50° C.

After evaporation of the water, in a convection oven at about 100° C., the PVC-free layer stack, comprising the uncured ethylenically unsaturated polyurethane resin, is mechanically embossed at a pressure of about 15 kg·cm⁻² while standing at a temperature of about 160° C. and subsequently subjected for 6 seconds to irradiation with ultraviolet light emitted by a 160 W/cm medium pressure mercury vapor UV-bulb (Fusion UV Systems Ltd) with a total UV dose of 1500 mJ/cm² while standing at a temperature of 40° C.

The adhesion of the polyurethane topcoat to the PVC-free top surface of the PVC-free layer stack was assessed by the cross-cut test according to ISO 2409-2013 09E2 “Standard Test Method for Measuring Adhesion by the Cross-Cut Test.”.

The coating was cut through with a series of several cuts at right angles in a defined manner using a Multi-Cross Cutter comprising 6 edges with a cutting distance of 2 mm.

The squared pattern (lattice) that is obtained is evaluated visually by examining the way in which the coating has broken away from the base material (along the cutting edges and/or complete squares) and comparing with the aid of the evaluation table.

The adhesion of the polyurethane topcoat to the PVC-free top surface of the PVC-free layer stack was also assessed by the tape test according to ASTM D3359-09E2 “Standard Test Method for Measuring Adhesion by the Tape Test.”

To the squared pattern of cuts, as performed according to ISO 2409-2013, a 25.4 mm wide Tesa Scotch 4124 pressure-sensitive tape was then firmly applied and rapidly removed.

The resulting squared pattern, after removal of the pressure-sensitive tape is evaluated visually by examining the way in which the coating has broken away from the base material (along the cutting edges and/or complete squares) and comparing with the aid of the evaluation table.

For both tests, ISO 2409-2013 and ASTM D335909E2, the below evaluation criteria apply:
grade 5: the edges of the cuts are completely smooth; none of the squares of the lattice is detached.
grade 4: small flakes of the coating are detached at intersections; less than 5% of the area is affected.
grade 3: small flakes of the coating are detached along edges and at intersections of cuts. The area affected is 5 to 15% of the lattice.
grade 2: The coating has flaked along the edges and on parts of the squares. The area affected is 15 to 35% of the lattice.
grade 1: The coating has flaked along the edges of cuts in large ribbons and whole squares have detached. The area affected is 35 to 65% of the lattice.
grade 0: Flaking and detachment worse than grade 1.

For the decorative surface covering, prepared according to the method as described above, a grade value between 4.5 and 5 was recorded on 10 different samples, for both the Cross-Cut and the Tape test.

For the ethylenically unsaturated coating, irradiated at a temperature lower than 25° C., lower grade values for the Cross-Cut and the Tape test were obtained.

The anti-slip properties of the decorative surface covering of the present invention were assessed according to DIN 51130:2010 “Testing of floor coverings—Determination of the anti-slip property—Workrooms and fields of activities with slip danger, walking method—Ramp test”

In this method a test person with test shoes walks forwards and backwards in an upright position over the floor covering to be tested, the slope of which is increased from the initial horizontal state to the acceptance angle (=angle of inclination until the limit of safe walking is reached and the test person slips). The acceptance angle is determined on floor coverings on which a lubricant has been applied.

For this test method the below evaluation criteria apply:

| Resistance class | Acceptance angle in ° |
|---|---|
| R9 | From 6 up 10 10 |
| R10 | Over 10 up to19 |
| R11 | Over 19 up to 27 |
| R12 | Over 17 up to 35 |
| R13 | Over 35 |

For the decorative surface covering, prepared according to the method as described above, a resistance class equal to or superior to R9 was recorded.

1. A PVC-free decorative surface covering, in particular floor or wall covering, comprising one or more polyolefin layer(s) and a cross-linked polyurethane top-layer comprising anionic or cationic salt groups.

2. The PVC-free decorative surface covering according to claim 1 wherein the one or more polyolefin layer(s) comprise one or more polyolefin homo and/or copolymer(s) selected from the group consisting of
an ethylene homopolymer,
an ethylene copolymer comprising alpha-olefins,
an olefin copolymer comprising vinyl carboxylate esters,
an olefin copolymer comprising alkyl (meth)acrylates,
a polyolefin elastomer and
a polar group comprising polyolefin.

3. The PVC-free decorative surface covering according to claim 1 wherein the cross-linked polyurethane top-layer comprises from 1 to 30% by weight of di-, tri- or tetra oxyethylene and/or di-, tri- or tetra oxypropylene units incorporated into the cross-linked polyurethane top-layer by two ester linkages.

4. The PVC-free decorative surface covering according to claim 1 wherein the cross-linked polyurethane top-layer comprises wear resistant particles.

5. The PVC-free decorative surface covering according to claim 1, comprising a mechanical embossed textured and/or patterned structure.

6. Method for the preparation of the decorative surface coverings according to claim 1 comprising the steps of:
a) providing one or more polyolefin layer(s),
b) subjecting the top surface of the one or more polyolefin layer(s) to a plasma treatment,
c) applying a radiation curable aqueous polyurethane dispersion on the top surface of said one or more polyolefin layer(s),
d) evaporating water from the aqueous dispersion to form an uncured top-layer comprising an ethylenically unsaturated polyurethane,
e) irradiating the ethylenically unsaturated polyurethane to form a cross-linked polyurethane top-layer.

7. The method according to claim 6 wherein the plasma treatment comprises a corona treatment that is adjusted to provide a surface energy of at least 38 mN/m, according to ASTM D2578.

8. The method according to claim 6 wherein the aqueous radiation curable polyurethane dispersion comprises 20 to 80% by weight, of radiation curable compounds and from 0.5 to 8% by weight relative to the radiation curable compounds, of at least one photoinitiator.

9. The method according to claim 6, wherein the radiation curable compounds of the aqueous radiation curable polyurethane dispersion comprise at least 50% by weight of one or more ethylenically unsaturated polyurethane resin(s) and at most 50% by weight of one or more reactive diluent(s).

10. The method according to claim 6, wherein the reactive diluents comprise between 20 and 100% by weight of one or more ethylenically unsaturated polyalkylene glycols selected from the group consisting of diethylene glycol di(meth)acrylate, triethylene glycol di(meth)acrylate, tetraethylene glycol di(meth)acrylate, dipropylene glycol di(meth)acrylate, tripropylene glycol di(meth)acrylate, tetrapropylene glycol di(meth)acrylate.

11. The method according to claim 6, comprising applying the aqueous dispersion of step c) at a temperature comprised between 25° C. and 60° C.

12. The method according to claim 6,
comprising the additional step of mechanical embossing the one or more polyolefin layer(s) comprising the uncured top-layer of step d) before initiating step e).

13. The method according to claim 6,
comprising performing mechanical embossing at a surface temperature comprised between 100° C. and 200° C.

14. The process method according to claim 6, comprising irradiating the dried coating in step e) at a temperature comprised between 30° C. and 70° C.

15. The PVC-free decorative surface covering according to claim 1, wherein the cross-linked polyurethane top-layer comprises from 2 to 20% by weight of di-, tri- or tetra oxyethylene and/or di-, tri- or tetra oxypropylene units incorporated into the cross-linked polyurethane top-layer by two ester linkages.

16. The method of claim 6, wherein the plasma treatment comprises a corona plasma treatment.

17. The method of claim 7, wherein the surface energy is of at least 38 mN/m.

18. The method of claim 7, wherein the surface energy is of at least 42 mN/m.

19. The method according to claim 6, wherein the aqueous radiation curable polyurethane dispersion comprises 25 to 60% by weight of radiation curable compounds and from 2 to 5% by weight, relative to the radiation curable compounds, of at least one photoinitiator.

20. The method according to claim 6, wherein the reactive diluents comprise between 30 and 90% by weight of one or more ethylenically unsaturated polyalkylene glycols selected from the group consisting of diethylene glycol di(meth)acrylate, triethylene glycol di(meth)acrylate, tetraethylene glycol di(meth)acrylate, dipropylene glycol di(meth)acrylate, tripropylene glycol di(meth)acrylate, tetrapropylene glycol di(meth)acrylate.

21. The method according to claim 6, wherein the reactive diluents comprise between 40 and 80% by weight of one or more ethylenically unsaturated polyalkylene glycols selected from the group consisting of diethylene glycol di(meth)acrylate, triethylene glycol di(meth)acrylate, tetraethylene glycol di(meth)acrylate, dipropylene glycol di(meth)acrylate, tripropylene glycol di(meth)acrylate, tetrapropylene glycol di(meth)acrylate.

22. The method of claim 11, wherein the temperature is between 30° C. and 50° C.

23. The method of claim 14, wherein the temperature is between 30° C. and 60° C.
